(19) United States
(12) Patent Application Publication
(10) Pub. No.: US 2010/0135038 A1
(43) Pub. Date: Jun. 3, 2010

(54) FRONTLIGHTS FOR REFLECTIVE DISPLAYS

(76) Inventors: Mark A. Handschy, Boulder, CO (US); John R. McNeil, Fort Collins, CO (US)

Correspondence Address: MARSH, FISCHMANN & BREYFOGLE LLP, 8055 East Tufts Avenue, Suite 450, Denver, CO, 80237, US

(21) Appl. No.: 12/628,015

(22) Filed: Nov. 30, 2009

Related U.S. Application Data
(60) Provisional application No. 61/118,644, filed on Nov. 30, 2008.

(51) Int. Cl. F21V 7/04

(52) U.S. Cl. 362/606; 362/611; 362/613

(57) ABSTRACT

A frontlight illuminator arrangement for a reflective display that includes a light guide and a pair of light sources coupled to the light guide at an angle that is neither normal to or orthogonal to a primary axis of the display. The light is internally reflected along the light guide until it is coupled into an optical element of similar refractive index that is adjacent to the light guide in the vicinity of the display. The optical element includes a multi-faceted beam splitter that reflects light back through the light guide onto the display where an image is formed and reflected back through the light guide and beam splitter.

### CROSS-REFERENCE TO RELATED APPLICATION

This application claims priority under 35 U.S.C. 119 to U.S. Provisional Application No. 61/118,644, entitled: “FRONTLIGHTS FOR REFLECTIVE DISPLAYS,” filed on Nov. 30, 2008, the contents of which are incorporated herein as if set forth in full.

### GOVERNMENT RIGHTS CLAUSE

This invention was made with Government support under Contract FA8650-06-C-6626 awarded by the United States Air Force Research Laboratory. The Government has certain rights in the invention.

### FIELD

The disclosure herein relates generally to illumination of reflective displays and more particularly to the illumination of reflective microdisplays, particularly liquid crystal on silicon microdisplays, for use in a variety of ways and applications including direct view displays, front and rear projection displays, electronic viewfinder displays, and head mounted displays.

### BACKGROUND

Reflective displays offer a range of advantages over emissive and transmissive displays. In the case of direct-view displays, reflective displays can be designed to be readable in ambient light, thus providing a high degree of readability even in circumstances where the ambient lighting is very bright, and offer low power consumption by not needing to energize a light-emitter or illuminator. In the case of reflective microdisplays intended for magnified viewing as opposed to direct viewing, either in a projection display or in a “virtual” display such as an electronic viewfinder or head-mounted display, the pixel aperture ratio (the fill factor of pixels relative to the overall size of the active area of the pixel array) can be high with the benefit of improved optical throughput, while the entire pixel area of a semiconductor substrate beneath the pixels can be occupied by sophisticated active-matrix electrical circuitry providing enhanced functionality, as described in U.S. Pat. No. 7,283,105 and in U.S. patent application Ser. No. 11/969,734. However, reflective displays come with their own set of challenges. Direct-view displays may require a form of artificial illumination for viewing at night or in situations where ambient light levels are low. Magnified reflective microdisplays generally need an optical element between the display and the imaging or magnifying optics to separate illumination and image light beams. For magnified reflective microdisplays, the illumination may be provided by a beam splitter, while for reflective direct-view displays, the illumination may be provided by a “frontlight,” a thin light guide with associated features that extract light from the guide and direct it towards the display. Illuminators using prior-art cube beam splitters generally deliver the good image quality needed for microdisplays that will be magnified for viewing, but are much bulkier than desired. As is common in the art, we will refer to a polarizing beam splitter made from a pair of rectangular prisms as a “cube” whether all three dimensions are equal or not. Frontlight illuminators, on the other hand, can be quite thin, but often degrade image quality to the point that they may not be suitable for many magnified microdisplay systems. Frontlights adapted for use with direct-view displays generally utilize light sources having an emitting area very small compared to the display area, such as, for example, light emitting diodes or cold-cathode fluorescent lamp tubes, and the light guide acts to spread the emitted light out over the face of a much-larger display active area that may be much more than ten times larger in area than the light source emitting area. In contrast, in a magnified microdisplay system the light output is limited by the maximum size of light source area that can be accommodated, and illumination structures that act to “spread” the illumination light would thus unnecessarily limit achievable display light output. These issues are further described with reference to FIG. 1 and FIG. 2.

FIG. 1 shows a typical prior-art optical arrangement with reflective microdisplay 107 illuminated with the aid of polarizing beam splitter (PBS) prism 101. Polarizing beam splitters are often used to provide illumination for reflective microdisplays that produce their display effect through selectively changing the polarization of light, such as liquid-crystal-on-silicon (LCOS) microdisplays. To simplify analysis of the size constraints, the reflecting surface 108 of microdisplay 107 is shown here in contact with a face of cube 101, although in practice it is usually spaced apart. Illuminator 110 emits light, a few exemplary rays of which are pointed out as 103, 104, and 111, which, upon reflection by beam splitting face 102, is directed towards microdisplay 107. Beam splitter face 102 is inclined at 45° to the reflecting plane 108 of microdisplay 107. A commonly used illumination condition, called telecentric illumination and illustrated here, illuminates all points on the microdisplay with circular cones of light, having their cone axes everywhere perpendicular to the reflecting face 108 of the microdisplay, and all having the same angle θ between their axis and their surface. For example, illumination ray 103 strikes the right edge of microdisplay face 108 to generate image ray 109; another illumination ray (not shown), symmetrically disposed around cone axis 116, strikes the same point on microdisplay face 108 to generate image ray 106. These rays lie on the surface of a cone having axis 116; desirably the entire interior of the cones are also uniformly filled with rays (which are not shown). Similarly, at the left edge of the microdisplay illumination ray 104, on the surface of its respective cone, is reflected to give image ray 105. To fulfill the aforementioned illumination condition, illuminator 110 must emit many other rays, but generally these are not shown to avoid overly confusing the drawing. In the view shown in FIG. 1, microdisplay 107 has a lateral width w, and is centered on the face of the PBS, leaving equal spaces between each of the left and right display edges and the nearest corresponding PBS edges. Requiring rays 105 and 106 to both exit through the top surface of PBS 101, as is required for most imaging-optics designs, determines the size of the PBS, as can be understood from the following. If each edge of PBS 101 has length a, then the space between the edge of the centered microdisplay and the edge of the PBS is (a−w)/2, which is also a tan θ; thus, a=w/(1−2 tan θ). Since the numerical aperture NA, which is used in the optical arts to characterize the angular acceptance of an optical system, is defined as n sin θ, where n is the refractive index of the PBS cube material, the size of the PBS can be expressed as a=w/{1−2[(n/NA)²−1]^{-1/2}}. In FIG. 1, a first bold line represents a first plane 114 coincident with microdisplay reflective surface 108, while a second bold line represents a parallel plane 115 defined as the plane of closest approach for an element of imaging optics, depicted here schematically as lens 113. By “closest approach” we mean the closest point at which all the imaging rays from display 107 are still available without the imaging optic interrupting any of the needed illumination rays. The distance between planes 114 and 115 defines what we mean by the height of the illuminator.

The curves graphed in FIG. 2 show size of the PBS, and hence in this case the height of the illuminator, relative to the extent of the display, as the ratio a/w, plotted as a function of NA, for polarizing beam splitters of various materials and glass types of different refractive indices. Several observations can be made. The fastest system of this configuration that can be implemented has tan θ=0.5, or θ=26.6°, giving the largest achievable NA as n/√5, which for air (e.g. a plate PBS operating in air, such as a wire-grid-polarizer plate) is 0.45 (ƒ/1.1). To achieve an optical system speed of ƒ/1 (NA=0.5) the cube refractive index must be at least 5/4=1.20. For PBS glasses of reasonable refractive indices (1.5-1.8) and optical systems of reasonable speeds (ƒ/3 to ƒ/1.7), the illuminator height will be between about 1.25 and 1.5 times the size of the display. The smallest illuminator height, which can be achieved with near-zero numerical apertures, is just more than one times the size of the display. Of course, for rectangular displays illuminator height is minimized by configuring the PBS hypotenuse (fold) across the shorter dimension of the display active area.

Many beam-splitter based variants of the system shown in FIG. 1 are known. The illumination can be transmitted through the PBS while the image is reflected without changing any of the essential size constraints. Microdisplay 107 can have it reflecting plane 108 spaced apart from cube 101; this only increases required illuminator height. Alternately, it is known to split the PBS cube in two, as disclosed in U.S. Pat. No. 5,596,451 (see FIG. 3D therein). A geometrical analysis similar to that above gives a/w=0.5/{1−[(n/NA)²−1]^{-1/2}}, indicating that in this case the smallest achievable illuminator height is half the width of the display. It is also known to incline the PBS face at angles other than 45°, for example at 30°, which appears to reduce the minimum illuminator height at NA=0 from being equal to the display size in the configuration of FIG. 1 to being √3/3≠0.58 times the display size. Further, it is known to curve the beam splitter, as disclosed in U.S. Pat. No. 5,808,800. It also known, in the case of displays that can act on unpolarized light but that selectively deflect light, such as the Texas Instruments DLP™ (Digital Light Processing displays to use a beam splitter comprising a pair of prisms with a thin air gap between so that, for example, incident illumination is totally reflected by the gap between the prisms towards the display, but, after the light is reflected by ON pixels of the display it is transmitted across the air gap between the prisms towards imaging or viewing optics, such as is disclosed in U.S. Pat. No. 6,461,000. To the best of applicant's knowledge, though, each of these variants still requires an illuminator height which is a substantial fraction of the display size; in any case always more than half the display size, and significantly more than half the display size when the system numerical aperture is substantially greater than zero.

FIGS. 3-5 shows how a reflective microdisplay might be illuminated by several different types of frontlight. In FIG. 3, exemplary ray 111 of illumination light emitted by illuminator 110 enters light guide 201. Light guide 201 might be made of a transparent material such as glass or polymer, with a refractive index substantially larger than 1, for example, 1.45 or higher as is this case for most glasses and transparent polymers. Light ray 111 bounces several times within guide 201, remaining trapped by total internal reflection until it strikes an extraction structure 202. The light extraction structure might be a groove, dimple, pit, rib, a spot of light scattering material, white paint, or the like. Extraction structures 202 could be made by topographic features in the surface of light guide 202 in contact with air, or in contact with some other material of refractive index differing from that of guide 202. The differing material could be optically isotropic, such as a liquid or as a transparent adhesive, or could be optically anisotropic such as a liquid crystal material. At any rate, when ray 111 strikes extraction structure 202 it is deflected and thereby may be directed towards reflective display 107. After being reflected off display 108, the ray traverses guide 201 to the region on the opposite side of guide 201 to display 107, where it can contribute to creating an image of display 107. The extraction structures 202 could be on the side of guide 201 opposite display 107, as shown in FIG. 3, or could be on the side of guide 201 facing display 107 (a configuration not shown in FIG. 3). The extraction structures in the configuration of FIG. 3 cover less than 100% of the area of the face of guide 201. This allows illumination light rays to bounce off of non-extracting regions 203 of the face of guide 201, as shown for exemplary ray 111, and continue to propagate further towards the edge of display 107 away from illuminator 110. It also allows rays reflected from the display, such as exemplary ray 206, to propagate from the display towards magnifying optics on the side of guide 201 opposite display 107 without perturbation or disturbance by extraction structures 202. Alternately, as illustrated in the configuration shown in FIG. 4, extraction structures 204 of a different type could be embedded or immersed within the body of light guide 201. Such extraction structures could be made from a thin transparent layer, for example an adhesive, having a refractive index somewhat different from that of guide 201. Alternately, they could be made by light scattering particles or fibers embedded more or less uniformly throughout the volume of guide 201. To enhance polarization sensitivity of the extraction the particle or fibers could be made of an optically anisotropic material with its anisotropy axes oriented parallel or perpendicular to the polarization direction of the incident illumination—alternately, the scattering material could be optically isotropic while the material of guide 201 was selected to be anisotropic such as would be obtained from stretched or drawn polyester films, made for example from polyethylene terephthalate (PET) or polyethylene naphthalate (PEN). It is straightforward to design the extraction structures to have extraction efficiency less than unity; that is to deflect a portion of the light towards display 107 while transmitting the remaining portion more or less unaffected. In this case, exemplary ray 111 encounters several extraction structures 203, and upon each encounter some of its light is extracted and deflected into a ray 205 directed toward display 107, with the intensity of illumination ray 111 being diminished after each encounter (indicated by the decreasing weight of the line depicting ray 111 in FIG. 4). In yet another frontlight configuration, shown in FIG. 5, light extraction could be provided by a more or less continuous coating, layer, or structure, 206, applied to the face of guide 201; this is to be contrasted with the discrete and separated extraction structures 202 of FIG. 3. Such a coating or layer might be made as a surface-relief diffraction grating (which grating structure could be filled with air, with an isotropic material of refractive index contrasting to that of guide 201, or with an anisotropic material such as liquid crystal to enhance the polarization sensitivity of the extraction efficiency). Alternately, the coating or layer could be made as a photopolymer in which a slanted volume hologram was formed. Again, exemplary illumination ray 111 may have several encounters with the light extracting layer or coating 206; upon each encounter a portion of its light is deflected into a ray 205 directed towards display 107 while the remaining portion remains trapped within guide 201. The intensity of illumination ray 111 again decreases as it travels further away from illuminator 110.

For illuminating small microdisplays with light sources having significant extent, that where the light source might have a Lambertian-emitting area as large as 5% or 10% or more of the display active area, the undesired feature common to all the frontlight configurations illustrated in the various parts of FIG. 3-5 is that they “spread out” the illumination beam. With illumination optics like those described with reference to FIG. 1, a microdisplay and its associated imaging optics might efficiently use a light source of a given, relatively large extent. On the other hand, with the “spreading-out” characteristic of the thinner frontlights described with reference to FIG. 3-5, the light source extent that can be efficiently used by the same microdisplay and magnifying optics will be reduced.

Many known frontlight types are less than ideal in other aspects with regard to providing illumination for a magnified microdisplay. Especially those that rely on the refractive-index differences between isotropic materials may suffer from inadequate quality of the display image. Some do not completely distinguish between illumination light and image light, and hence have their efficiency reduced by returning part of the illumination light reflected off the display back to the illuminator. Many emit illumination towards the reflective display at an angle inclined to the display normal, which complicates their practical use. Frontlights that rely on diffraction or holographic effects may emit illumination light of different colors at different angles. This complicates the viewing of the display or its insertion into a magnifying optical system by enlarging the range of angles the magnifying optics must accept. It is against this background that the frontlight arrangements described herein have been developed.

### DRAWING DESCRIPTION

FIG. 1 is a side view of a prior art frontlight illuminator arrangement for a reflective microdisplay, the arrangement using a single polarizing beam splitter (PBS) cube.

FIG. 2 is a graphical representation of the size of the PBS relative to the size of the display versus the numerical aperture for various PBS glass types.

FIGS. 3-5 show three different prior art frontlight illuminator arrangements.

FIG. 6 shows a novel frontlight illuminator arrangement.

FIG. 7 shows various light rays and selected angles according to a beam splitter structure of the illuminator of FIG. 6.

FIG. 8 shows various aspects relating to the height of the illuminator of FIG. 6.

FIG. 9 shows a portion of the beam splitter structure of the illuminator of FIG. 6.

FIG. 10 shows features relevant to a method for fabricating the illuminator of FIG. 6.

### DETAILED DESCRIPTION

While the embodiments of the present invention are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims.

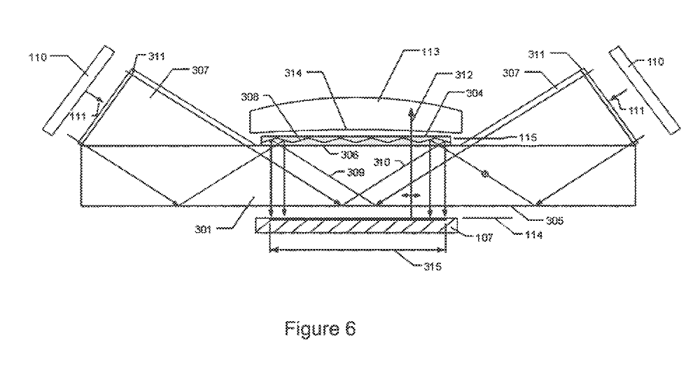

FIG. 6 shows an embodiment of a frontlight according to the present invention. A transparent plate 301 sits above a reflective microdisplay 107, acting as a light guide. Light from a pair of light sources 110 is launched into plate 301 from opposite ends, the light rays 111 from sources 110 generally being directed towards face 305 of plate 301 adjacent display 107. Input coupling prisms 307 may be attached and optically coupled to plate 301 to facilitate launching illumination light rays at the desired angles described below. Plate 301 may be made from a transparent material such as glass, which desirably has low birefringence, and may be situated relative to display 107 so as to leave a gap filled with a low-refractive-index medium such as air between itself and the display. Light sources 110 are arranged, and the refractive index of plate 301 is chosen, so that the angles of incidence of light rays striking face 305 are greater than the critical angle and hence are totally internally reflected. Upon reflection, the light rays are directed generally towards face 306 of plate 301, which face is opposite display 107 and may be approximately parallel to face 305. A structure 304 having a shaped beam splitter 308 therein is attached and optically coupled to face 306. Beam splitter 308 is shaped in a series of “triangular” facets, pitches or ridges, somewhat like a roof with multiple gables. Beam splitter 308 is preferably a polarizing beam splitter when display 107 requires polarized light such as is the case for most LCOS displays. Such polarizing beam splitters can be made in several different ways. For example, it could be made from a wire-grid polarizer, such as is commercially available on glass-plate substrates from Moxtek (Orem, Utah) or as has been taught in flexible-film form by, for example, by S. H. Ahn and L. J. Guo, in their paper “High-Speed Roll-to-Roll Nanoimprint Lithography on Flexible Plastic Substrates,” in Advanced Materials vol. 20, pp. 2044-2049 (2008). Alternately, beam splitter 308 in polarizing form could be made from multilayer birefringent films such as those produced by the 3M Corporation (St. Paul, Minn.) and described by S. Magarill and C. L. Bruzzone, in their paper “Detailed optical characteristics of multi-layer optical film polarization beam splitter,” published in the Journal of the Society for Information Display vol. 15, 811-816 (2007). Suitable polarizing beam splitter structures could also be made from cholesteric liquid crystals, such as described by N. Y. Ha, Y. Ohtsuka, S. M. Jeong, et al., in their paper “Fabrication of a simultaneous red-green-blue reflector using single-pitched cholesteric liquid crystals,” published in Nature Materials vol. 7, pp. 43-47 (2008), or such as described by Y. Huang, Y. Zhou, and S.-T. Wu, in their paper “Broadband circular polarizer using stacked chiral polymer films,” published in Optics Express vol. 15, pp. 6414-6419 (2007).

The angles of the “facets” of beam splitter 308 are chosen to reflect the illumination rays, such as ray 309 and ray 310, toward display 107. The facet angles can be chosen so that, if desired, the rays reflected by beam splitter 308 strike display 107 at close to normal incidence. In the case that beam splitter 308 is a polarizing beam splitter, the illumination from light source 110 is preferably pre-polarized, for example by pre-polarizers 311 which may be attached directly to input coupling prisms 307 or to the light sources 110 in some manner. By appropriately orienting the polarization direction of beam splitter 308 and the polarization state of the illumination light, the illumination rays, such as ray 309 and ray 310, can be almost completely reflected by beam splitter 308 towards display 107. Face 305 can be coated with dielectric coatings to minimize optical phase shifts that might otherwise occur upon total internal reflection, in order to maintain the polarization state desired for efficient reflection off of beam splitter 308.

In the case that display 107 acts on light by selectively changing its polarization, as would be the case if it were an LCOS display, so that, for example, OFF pixels reflect illumination without changing its polarization state and that fully ON pixels reflect illumination with its polarization changed to the orthogonal state, the ON-state light can be nearly fully transmitted through beam splitter 308, as shown for ray 312. This ON-state light can then proceed to the imaging or viewing optics, of which the element closest to display 107 is shown schematically in the figure as lens 113. Structure 304 immerses the facets of beam splitter 308 in a medium of uniform refractive index so that the rays that contribute to the image, such as ray 312, are transmitted through beam splitter 308 without substantial deviation.

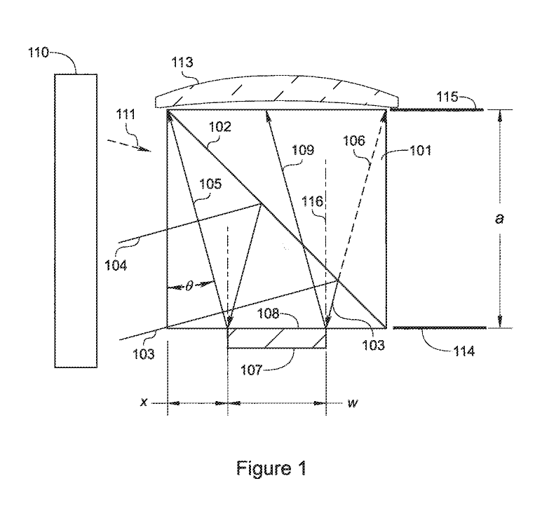

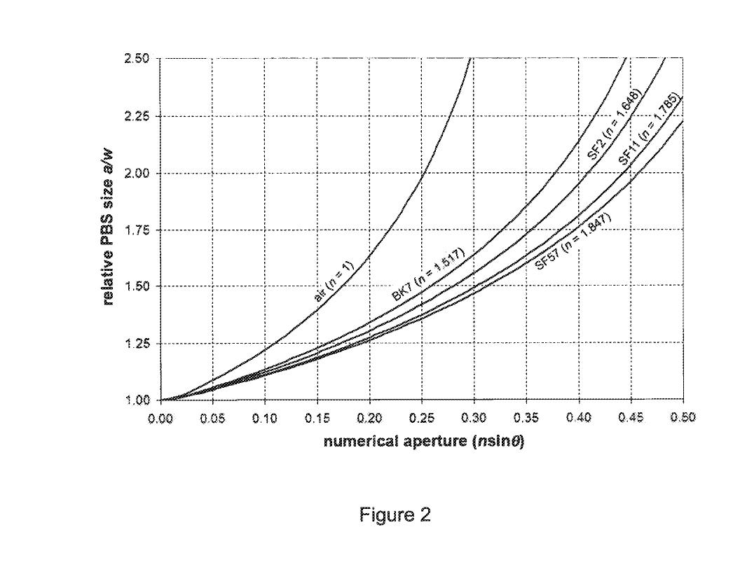

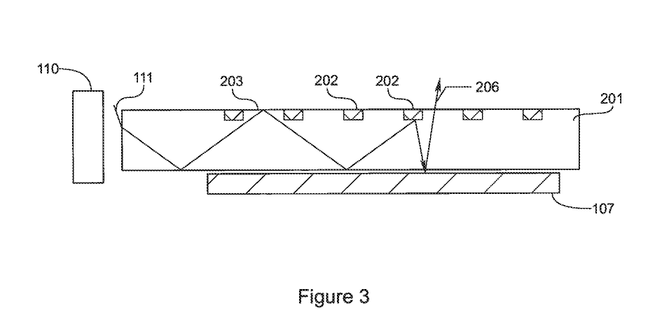

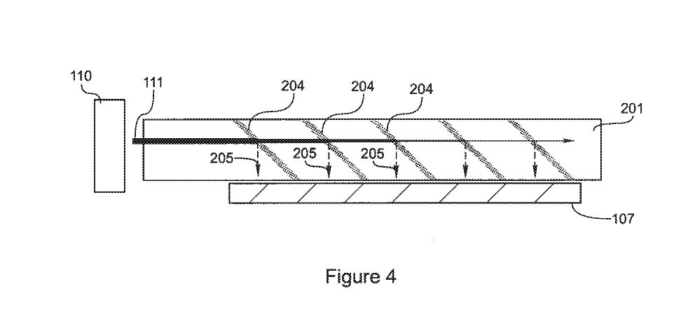

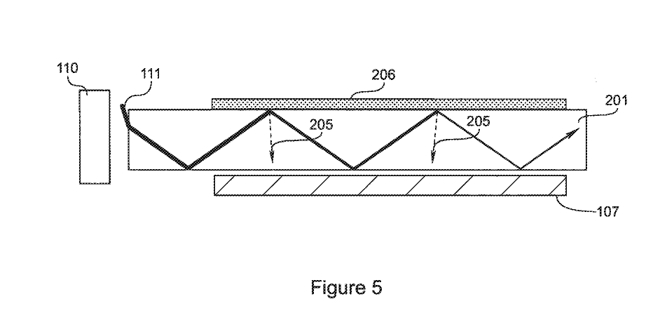

FIG. 6 shows display 107 having a lateral extent or width 315. As described above with reference to FIG. 1, a first bold line represents a plane 114 coincident with the reflective surface of microdisplay 107 while a second bold line represents plane 115, parallel to plane 114, defined as the closest that lens 113 can approach without interrupting the needed illumination rays. The distance between planes 114 and 115 defines the height of the illuminator. The illuminator of the present invention can have a smaller height relative to the lateral extent of the display compared to prior illuminators for reflective displays.

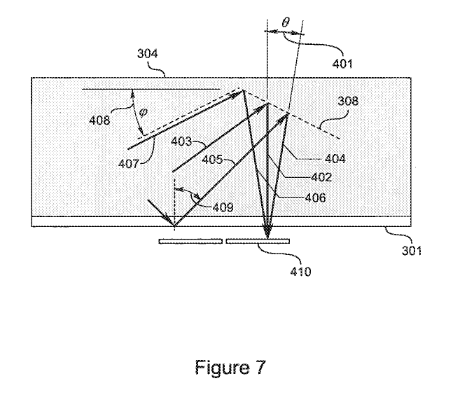

The heights of reflective-display illuminators, both those found in the prior art and those disclosed herein, have a height that depends on the numerical aperture (NA) of the optical system. In the case of the embodiment described with reference to FIG. 6, the way in which its height depends on NA can be described with further reference to the rays shown in FIG. 7. Display 107 includes an array of reflective pixels, such as pixel 410. Each point on each pixel may be illuminated by light rays filling a cone having its axis substantially perpendicular to the reflective surface of display 107. Principal ray 402 travels along the cone axis. Rays 404 and 406, lying on the surface of the illumination cone and in the plane of the section depicted in FIG. 7, make an angle θ 401 to the principal ray within structure 304. Structure 304 is made of a medium having refractive index n, which might be larger than one, confined between planar surfaces parallel to the reflective plane of display 107. The illumination then has NA=n sin θ. The principal ray 402 striking pixel 410 comes from the reflection of ray 403 off of beam splitter 308. Similarly, ray 404 comes from the reflection of ray 405, and ray 406 comes from the reflection of ray 407. A full cone of illumination at all the various points within the pixel array of display 107 can be provided according to an embodiment of the present invention if the rays of illumination light incident on beam splitter 308, such as rays 403, 405, and 407, are not obstructed by the facets of beam splitter 308. This can be ensured if facet angle 408 having a value φ (measured relative to a plane parallel to the reflective plane of display 107) is no larger than the angle (also measured relative to a plane parallel to the reflective plane of display 107) made by ray 407. Making the facet angle as steep (large) as possible without obstructing any rays yields the smallest illuminator height. The lowest-height illuminator free from any ray obstruction is obtained when φ=30°−θ/3. For example, in a medium of refractive index n=1.598 an optical system speed of ƒ/2 or NA=0.25 is obtained with a ray cone having an opening angle θ=9°, in which case beam splitter facet angles of φ=27° would be appropriate. Ray 405 may reflect off the face of plate 301 adjacent display 107 by total internal reflection, which requires that angle 409 be larger than the critical angle. Given that beam splitter facet angle 408 is chosen according to the condition φ=30°−θ/3 ray 405 will make an angle 409 equal to 60°−5θ/3 relative to the face of plate 301 off which the ray reflects in the exemplary case illustrated here where plate 301 and beam splitter structure 304 are made from materials have the same or rather similar refractive indices. For the exemplary refractive index n=1.598, total internal reflection could be obtained under the aforementioned design conditions for θ<12.7°, or for NA<0.35 (ƒ/1.4).

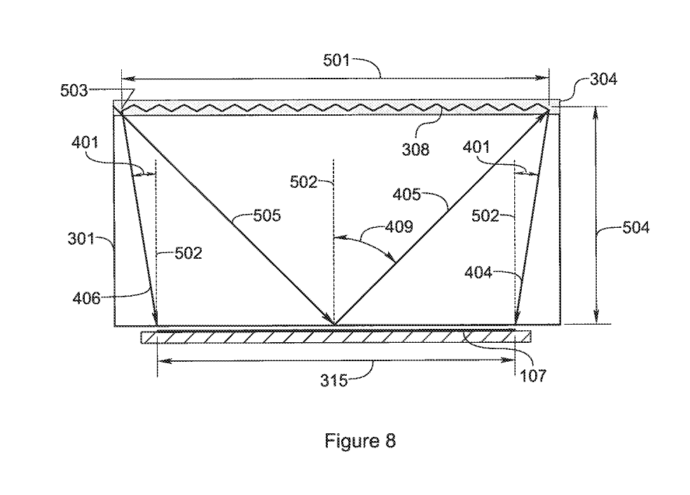

The overall height of an illuminator according to an embodiment of the present invention can be elucidated with reference to the illuminator elements as shown in FIG. 8. In this figure, the facets of beam splitter 308 have been angled in accordance with the above teaching to take the steepest angle possible without obstructing any of the incident rays needed to fill an illumination cone of opening angle θ directed towards the various points on the reflective surface of display 107. This reflective surface has a lateral extent or width 315 in principal plane of incidence of the illumination rays. The extreme incident ray 405 making the steeper angle strikes beam splitter 308 at the beam splitter's furthest point (to the right in FIG. 8) and is reflected to make ray 404 which in turn strikes the reflective surface of display 107 at its furthest point (again furthest to the right in the figure), having an angle of incidence 401 measured relative to surface normal 502 equal to θ. Given that the facets of beam splitter 308 are tilted in accordance with the teachings above, ray 405 has an angle of incidence 409 equal to 60°−5θ/3 within the medium of plate 301 in the case where the refractive index of plate 301 matches the refractive index of structure 304 which immerses beam splitter 308. Beam splitter 308 desirably has sufficient lateral extent or width 501 to reflect rays, such as ray 404, toward the furthest illuminated points on display 107 at large enough angles of incidence to fill an illumination cone of opening angle θ. This in turn requires that beam splitter width 501 be somewhat greater than display surface width 315. In fact, if display surface width 315 is equal to w, and illuminator height 504 is equal to h, then beam splitter 308 desirably has a width about equal to w+2h tan θ. In order for it to be possible to introduce incident illumination ray 505, which reflects to give ray 405, without its being obstructed by edge 503 of beam splitter 308 (the beam splitter centered over the reflective surface of display 107), illuminator height h must be at least (w/2+h tan θ)tan(30°−5θ/3), which gives the minimum illuminator height relative to the width of the display active area as:

h/w≧1/{2[tan(60°−5θ/3)−tan θ]}.

For example, assuming the material of plate 301 and the material of structure 304 both have refractive index n=1.648, and that the illumination system operates at NA=0.2 (θ/2.5), then the cone of illumination rays would have an opening angle θ=6.97°. In this case, the illuminator could have height relative to the display width as small as h/w=0.498 (neglecting the small air space between display 107 and plate 301 and neglecting the height of the facets of beam splitter 308); the illuminator could be slightly less in height than half the display width.

By making plate 301 of a transparent material having a refractive index somewhat less than that of the material of structure 304 which immerses beam splitter 308, the illuminator height can be reduced even further beyond the height it would need to have in the case described immediately above where these two materials had the same refractive index.

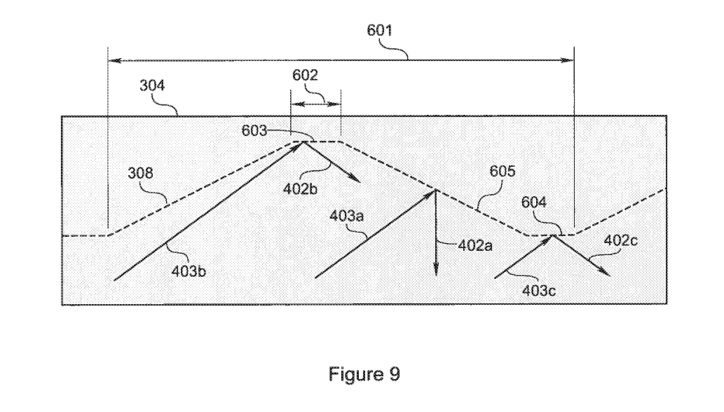

Making the vertices where oppositely-tilted facets of beam splitter 308 meet as sharp as is practical can increase the optical throughput of the display and illuminator system, and can increase the achievable uniformity of illumination provided to display 107, as is further described with reference to FIG. 9. Incident illumination ray 403a strikes a surface 605 of beam splitter 308 at a location where that surface is tilted at an angle according to the teaching above. This ray reflects to give ray 402a, which proceeds, in this exemplary case, essentially parallel to the optical axis or surface normal of display 107, thereby making it a principal illumination ray of telecentric illumination. Rays 403b and 403c, however, strike beam splitter 308 at surfaces 603 and 604, respectively, where rounding or, in the exemplary case shown here, flattening, causes the surfaces of beam splitter 308 to deviate from their ideal angles. Because of this deviation, rays 402b and 402c are reflected at angles away from the desired angle which would have made them principal illumination rays. Instead, the rounding or flattening of the beam splitter surfaces causes them to be reflected at more oblique angles, in turn causing them not to be directed towards the points on the reflective surface of display 107 immediately beneath surfaces 603 and 604. In fact, given that rays 403b and 403c arrived at beam splitter 308 after having been totally internally reflected off the face of structure 304, and that rays 402b and 402c will again strike the face of structure 304 at the same angle, these rays will, rather than striking a pixel on display 107, be totally reflected within structure 304 again. Thus, these rays will likely not contribute to the illumination of display pixels immediately below their point of reflection off of beam splitter 308. This effect might result in some non-uniformity in the illumination of the surface of display 107, with the regions of the display immediately beneath the flattened or rounded vertices of beam splitter 308 being less fully illuminated than those regions beneath the more smooth surfaces of beam splitter 308.

In the ideal case, the oppositely-angled facets of beam splitter 308 would meet in lines or curves of negligible lateral extent, but in many case of practical interest this may not be feasible. Non-uniformities in illumination intensity may be avoided or mitigated, however, by making the pitch 601 of the beam splitter facet arrangement relatively fine or small. For chosen illuminator height h and illumination cone angle θ, the diameter of the illumination cone will be approximately equal to 2h tan θ in the plane of beam splitter 308. If the pitch 601 of the beam splitter facet structure is such that several cycles of alternating facet angles will occur within this diameter, then any otherwise-occurring illumination non-uniformities will be smoothed out, and all the pixels of display 107 will be more-or-less equally illuminated. For example, if display 107 has a width 315 equal to 6 mm, and is illuminated by cones of light having NA=0.25, and if both structure 304 and plate 301 have refractive index n=1.5, then the illumination cones have an opening angle approximately equal to 9.6°, and the illuminator with minimum height has height h≈3.8 mm. At the plane of beam splitter 308, the illumination cone then has a diameter equal to 1.3 mm. If the pitch of the facets of beam splitter 308 were small compared to 1.3 mm, for example, each facet having a width of 0.2 mm or so, then the illumination losses produced by any flattenings or roundings of the vertices of beam splitter 308 would occur more or less equally for any of the pixels comprising the reflective surface of display 107.

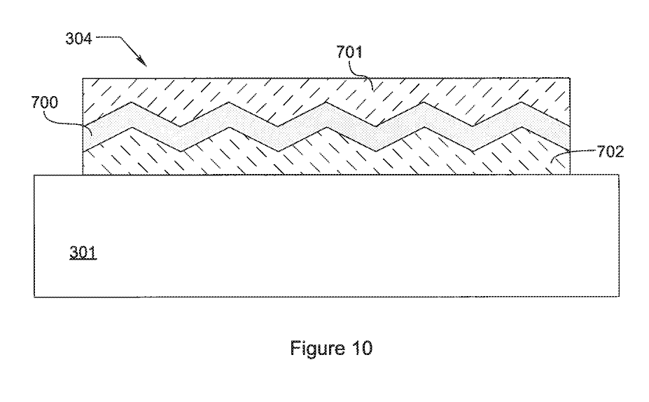

Beam splitter 308 and structure 304 can be fabricated by any of a variety of methods. For example, suitable polarizing beam splitters are available commercially in the form of polymer films. Minnesota Mining and Manufacturing (3M, St. Paul, Minn.) provides films made from a stack of thin polymer layers arranged so that for a first light polarization the layers of the stack have all substantially the same refractive index, but for the second, orthogonal polarization, the layers have alternating high and low refractive indices. 3M markets some of these films under the name DBEF (for double brightness enhancing film). Alternately, Asahi Kasei (Tokyo) provides polymer films with a wire-grid polarizer structure on one surface, the films made by embossing a polymer-film substrate with nanometer-scale ridges, which ridges are then shadowed with an oblique evaporative coating of aluminum. Such beam-splitter films can be formed into structures suitable for embodiments of the present invention by methods similar to those in the following example described with reference to FIG. 10. A prismatic structure 701 could first be made from a molded or embossed polymeric material using methods similar to those used in the art for fabricating Fresnel lenses. The polymeric material making structure 701 would desirably have a refractive index close to or matching that of the chosen beam splitter film material, particularly matching that of the chosen beam splitter film experienced by light transmitted through the film in the case that the film exhibits optical anisotropy. Second, a beam splitter film 700 of one of the types described above could be fitted to the prismatic structure 701. To aid obtaining a close fit, the beam splitter film could beforehand be stamped or pressed to a mold similar to the one used to make structure 701, the film perhaps being heated at the time of pressing. Alternately or additionally, to minimize rounding or flattening of the vertices, the film could be scored at appropriate intervals. The scoring could be accomplished by cutting less than all the way through the film with a knife or with a laser beam. Since alternate vertices of the film are bent in opposite directions it may be desirable to alternate the side from which the film is scored. Thirdly, any space between the film and prismatic structure 701, and between the film and plate 301, can be filled with an adhesive or casting polymer as designated by numeral 702, the filling material preferably having a refractive index matching that of prismatic structure 701. Matching the refractive indices of film 700, prismatic structure 701, and filling material 702, minimizes the distortions or aberrations introduced into the image made from light reflected from display 107.

In another embodiment, the beam splitter 308 is formed in situ on prismatic structure 701, for example by making ridges on structure 701 by the techniques known in the art of nano-imprint lithography, and then evaporating aluminum at oblique incidence onto the ridges to form a wire-grid polarizer. After forming the wires, structure 701 could again be coupled to plate 301 by filling a space between structure 701 and plate 301 with an index matching liquid, gel, adhesive, or the like. When beam splitter 308 is a polarizing beam splitter and display 107 operates by affecting the polarization of reflected light, it is desirable that beam splitter structure 304 preserve the polarization of incident illumination light in order to avoid degrading the contrast ratio of the display. To this end, it may be desirable that elements of the illuminator such as plate 301 and filling material 702 have minimal birefringence. Once the light reflected by the display has been transmitted through beam splitter 308, the deleterious effects of birefringence of subsequently encountered optical elements is reduced or eliminated. Thus, significant birefringence may be tolerated in prismatic structure 701.

Light can be coupled into the frontlight structure by a variety of arrangements, of which the prism couplers shown in FIG. 6 constitute only one example. Alternately, light from light sources 110 could be coupled in by Fresnel-prism structure applied to the surface of plate 301, with a lower resulting overall size compared to the bulk prism couplers shown in FIG. 6. The Fresnel-prism coupling structures could desirably present faces normal or nearly normal to those light rays 311 that eventually, after reflections, became principal rays incident on the pixel-array surface of display 107 at normal incidence. In a further embodiment, the Fresnel-prism coupling structure could be modified to be a Fresnel-coupling structure, providing a collimating function for light source 110. Further, the frontlights of the present invention may be provided with light sources 110 and associated light-coupling structures on two opposing sides of the frontlight.

The frontlight arrangements described herein have many beam splitter facets with the resulting height of structure 304 being small. However, this is not necessary. In fact, beam splitter 308 need only have a few facets, for example, two facets, four facets, or six facets. Such few-facet structures can give illuminator heights less than many-facet structures, particularly if the facets closest light sources 110 are angled so that they are furthest away from display 107 at their outer edges and then slope downwards towards the display as one proceeds inwards towards the center of the display.

The frontlights disclosed herein provide illumination elements for reflective displays. Illumination systems with the disclosed frontlights provide efficient illumination of reflective displays while simultaneously allowing imaging optics, if used, such as a projection lens, eyepiece optic, or magnifier, to create a sharp, clear, un-degraded image of the display. The frontlights disclosed herein enable illumination of reflective display while maintaining thinner profile than prior-art illumination architectures having comparable efficiency and image quality. They act to efficiently provide illumination to the reflective display without themselves, in some embodiments, intercepting much, if any, of the light reflected off the display that ultimately creates the display image. In disclosed embodiments, they enable bright displays with high light outputs by enabling the efficient use of illumination light sources with large extent, working efficiently up to the limit where the &endue of the light source coupled into the frontlight fills the &endue determined by the area of reflective display and acceptance angle of the magnifying optics. Some of the frontlights disclosed here reduce the complexity of reflective-display optical systems by providing illumination light rays within a cone having its axis substantially perpendicular to the emitting face of the frontlight, and by providing substantially the same emission-angle characteristic independent of the color or wavelength of the illumination light.

While the embodiments of the invention have been illustrated and described in detail in the drawings and foregoing description, such illustration and description is to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

1. An apparatus for displaying an image, comprising:
a display comprising an array of pixels, the pixels lying on a first surface, the array of pixels having a predetermined lateral extent in the first surface;
a light source;
an illumination apparatus for receiving light from the light source and directing it to the display;
imaging optics for conveying light reflected from the display to a viewing region, the optics making from the conveyed light either a real or virtual image of the display, the optics having an object side surface closest to the first surface; and
wherein the object side surface of the imaging optics is within a distance of the first surface that is equal to or closer than 58% of the lateral extent of the pixel array area.

2. An apparatus as defined in claim 1, wherein the object side surface of the imaging optics is within a distance of the first surface that is approximately half of the lateral extent of the display.

3. An apparatus as defined in claim 1, wherein the object side surface of the imaging optics is within a distance of the first surface that is approximately ((w/2)(tan 30°+5θ/3))/(1−(tan θ)(tan 30°+5θ/3)), where w is the lateral extent of the display and θ is the opening angle of the illumination cone of light (in degrees).

4. An apparatus for displaying an image, comprising:
a display comprising an array of pixels lying in a plane, the display having a primary optical axis that is substantially orthogonal to the plane;
a light source having a primary axis that illuminates the display, the primary axis of the light source being neither orthogonal to nor parallel with the primary axis of the display;
a light guide that is receptive of light from the light source and which directs the received light toward the display.

5. An apparatus as defined in claim 4, further including an optical element adjacent a portion of the light guide on a side of the light guide opposite from the side of the light guide closest to the display;
wherein the light received by the light guide is reflected along the light guide until it reaches the region of the light guide at which the optical element is adjacent the light guide to allow at least a portion of the light reflected along the light guide to enter the optical element and be directed back through the light guide toward the display.

6. An apparatus as defined in claim 5, wherein the optical element includes a shaped beam splitter that reflects light from the light source and transmits light from the display.

7. An apparatus as defined in claim 6, wherein the shaped beam splitter includes a series of facets, at least one portion of which are angled so as to receive a portion of the light reflected along the light guide from the light source.

8. An apparatus as defined in claim 7, wherein the light source is a first light source, and the apparatus further includes a second light source, wherein the first light source directs light into a first end of the light guide and the second light source directs light into a second end of the light guide, and wherein the series of facets in the shaped beam splitter includes another portion which are angled so as to receive a portion of the light reflected along the light guide from the second light source.

9. An apparatus as defined in claim 8, wherein the one portion of facets are interleaved between the another portion of facets.

10. An apparatus as defined in claim 9, wherein each of the one portion of facets are substantially parallel to each other and each of the another portion of facets are substantially parallel to each other.

11. An apparatus as defined in claim 4, wherein the light source is a first light source, and the apparatus further includes a second light source, wherein the first light source directs light into a first end of the light guide and the second light source directs light into a second end of the light guide.

12. An apparatus for displaying an image, comprising:
a display comprising an array of pixels lying in a plane, the display having a primary optical axis that is substantially orthogonal to the plane;
a light source having a primary axis that illuminates the display, the primary axis of the light source being neither orthogonal to nor parallel with the primary axis of the display;
a light guide that is receptive of light from the light source and which directs the received light toward the display; and
an optical element adjacent a portion of the light guide on a side of the light guide opposite from the side of the light guide closest to the display, wherein the optical element includes a shaped beam splitter that reflects light from the light source and transmits light from the display, wherein the shaped beam splitter includes a series of facets, at least one portion of which are angled so as to receive a portion of the light reflected along the light guide from the light source;
wherein the light received by the light guide is reflected along the light guide until it reaches the region of the light guide at which the optical element is adjacent the light guide to allow at least a portion of the light reflected along the light guide to enter the optical element and be directed back through the light guide toward the display.

13. An apparatus as defined in claim 12, wherein the light source is a first light source, and the apparatus further includes a second light source, wherein the first light source directs light into a first end of the light guide and the second light source directs light into a second end of the light guide, and wherein the series of facets in the shaped beam splitter includes another portion which are angled so as to receive a portion of the light reflected along the light guide from the second light source.

14. An apparatus as defined in claim 13, wherein the one portion of facets are interleaved between the another portion of facets.

15. An apparatus as defined in claim 14, wherein each of the one portion of facets are substantially parallel to each other and each of the another portion of facets are substantially parallel to each other.
